(19) United States
(12) Patent Application Publication
(10) Pub. No.: US 2025/0160600 A1
(43) Pub. Date: May 22, 2025

(54) RENEWABLE CLEANING DEVICE

(71) Applicant: Burhan Ozgunaydin, Freehold, NJ (US)

(72) Inventor: Burhan Ozgunaydin, Freehold, NJ (US)

(21) Appl. No.: 18/435,344

(22) Filed: Feb. 7, 2024

Related U.S. Application Data
(63) Continuation-in-part of application No. 18/512,937, filed on Nov. 17, 2023.

(51) Int. Cl. A47L 13/17; A47L 13/42; B32B 5/02; B32B 5/26; B32B 7/06; B32B 7/12

(52) U.S. Cl. CPC A47L 13/17; A47L 13/42; B32B 5/02; B32B 5/26; B32B 7/06; B32B 7/12; B32B 2250/20; B32B 2260/023; B32B 2260/046; B32B 2307/726; B32B 2307/748; B32B 2432/00

(57) ABSTRACT

A renewable cleaning device is provided which has a plurality of cleaning surfaces which can be individually revealed to provide the cleaning devices with renewed cleaning surfaces. The device may include a body having two or more flexible material layers that may be removably coupled together, and each flexible material layer may comprise two major surfaces that may function as cleaning surfaces. One or more, such as all, flexible material layers may include a cleaning agent. Optionally, the two or more flexible material layers may be removably coupled together via compressing the two or more flexible material layers together so that they may be separated without damaging the two flexible material layers. Optionally, the two flexible material layers may each be removably couple together via adhesive layers so that they may be separated without damaging the two flexible material layers.

### CROSS REFERENCE TO RELATED APPLICATIONS

This application is a continuation-in-part of U.S. Non-Provisional application Ser. No. 18/512,937, filed on Nov. 17, 2023, entitled “RENEWABLE CLEANING DEVICE”, which is hereby incorporated by reference in its entirety.

### FIELD OF THE INVENTION

This patent specification relates to the field of cleaning devices. More specifically, this patent specification relates to a cleaning device having a plurality of inner cleaning layers that are revealed by removing outer cleaning layers.

### BACKGROUND

Cleaning objects is an essential component of home life and professional life for many individuals. Typically, these individuals use cleaning instruments, such as cloths and sponges, to wipe and scrub surfaces and objects. Due to the nature of this use and with the use of cleaning products, the cleaning surfaces of these cleaning instruments can become worn to the point of decreasing their effectiveness. Users must then discard the entire cleaning instrument and replace it with another one. Not only is this time consuming and costly, but this leads to increased waste. Additionally, many users must add a cleaning agent to their cleaning instruments and/or to the object that they desire to clean which results in requiring the users to keep track of manage two or more cleaning agents and cleaning instruments during a cleaning process.

Therefore, a need exists for novel cleaning devices. A further need exists for novel cleaning devices which have a plurality of cleaning surfaces which can be individually revealed to provide the cleaning devices with renewed cleaning surfaces. A further need exists for novel cleaning devices which decrease the need for a user to manage and keep track of one or more cleaning agents.

### BRIEF SUMMARY OF THE INVENTION

A renewable cleaning device is provided which has a plurality of cleaning surfaces which can be individually revealed to provide the cleaning devices with renewed cleaning surfaces and which decreases or eliminates the need for a user to manage and keep track of one or more cleaning agents.

In some embodiments, the device may include a body having two or more flexible material layers, and each flexible material layer may include a water absorbing material. One or more flexible material layers may include a cleaning agent dispersed or otherwise applied to it or within it. The flexible material layers may be coupled together via compressing the flexible material layers together, and the flexible material layers may be removably coupled to each other so that they may be mechanically separated from each other, such as by peeling or pulling apart, without damaging the structural integrity of the flexible material layers.

In some embodiments, a cleaning agent may comprise one or more detergents, surfactants, enzymes, solvents, and/or bleaching agents.

In some embodiments, each flexible material layer may include and/or may be microfiber fabric impregnated with polyvinyl alcohol. Microfiber fabric impregnated with polyvinyl alcohol provides water absorption capabilities that are many times greater than other existing commonly used sponge and fabric materials. Through extensive testing, it has been determined that a renewable cleaning device having each flexible material layer made from microfiber fabric impregnated with polyvinyl alcohol has extreme absorbing ability and is able to retain a cleaning agent within the flexible material layers so that it can be used 30-40 times (e.g., used by adding water and squeezing the device 3-4 times, so that it is ready to use for cleaning purposes).

In some embodiments, the device may include a body having two flexible material layers and an adhesive layer, and each flexible material layer may include a water absorbing material. One or more flexible material layers may include a cleaning agent dispersed or otherwise applied to it or within it. The two flexible material layers may be coupled together via an adhesive, so that the adhesive layer removably couples the two flexible material layers together so that they may be separated without damaging the two flexible material layers.

In further embodiments, the device may include a plurality of flexible material layers and a plurality of adhesive layers. Each flexible material layer of the plurality of flexible material layers may be coupled to an adjacent flexible material layer via an adhesive layer of the plurality of adhesive layers so that the plurality of adhesive layers removably couple the plurality of flexible material layers together.

In further embodiments, each flexible material layer of the plurality of flexible material layers is made from a first material so that each flexible material layer is made from the same material, and each adhesive layer of the plurality of adhesive layers is made from a second material so that each adhesive layer is made from the same material, the material of the adhesive layers being a different material than that of the flexible material layers.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of a first example of a renewable cleaning device according to various embodiments described herein.

FIG. 2—FIG. 2 illustrates a perspective view of a first example of a renewable cleaning device having a partially removed first flexible material layer according to various embodiments described herein.

FIG. 3—FIG. 3 shows a perspective view of a first example of a renewable cleaning device having a completely removed first flexible material layer according to various embodiments described herein.

FIG. 4—FIG. 4 depicts an enlarged sectional, elevation view of another example of a renewable cleaning device according to various embodiments described herein.

FIG. 5—FIG. 5 shows a perspective view of a second example of a renewable cleaning device according to various embodiments described herein.

FIG. 6—FIG. 6 illustrates a perspective view of a second example of a renewable cleaning device having a partially removed first flexible material layer according to various embodiments described herein.

FIG. 7—FIG. 7 shows a perspective view of a second example of a renewable cleaning device having a completely removed first flexible material layer according to various embodiments described herein.

FIG. 8—FIG. 8 depicts an enlarged sectional, elevation view of a further example of a renewable cleaning device according to various embodiments described herein.

FIG. 9—FIG. 9 shows a perspective view of a renewable cleaning device having a generally square prism shaped body according to various embodiments described herein.

FIG. 10—FIG. 10 illustrates a perspective view of a renewable cleaning device having a generally cylindrical shaped body according to various embodiments described herein.

FIG. 11—FIG. 11 shows a perspective view of a renewable cleaning device having a generally triangular prism shaped body according to various embodiments described herein.

FIG. 12—FIG. 12 shows a perspective view of a renewable cleaning device having a generally cube shaped body according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

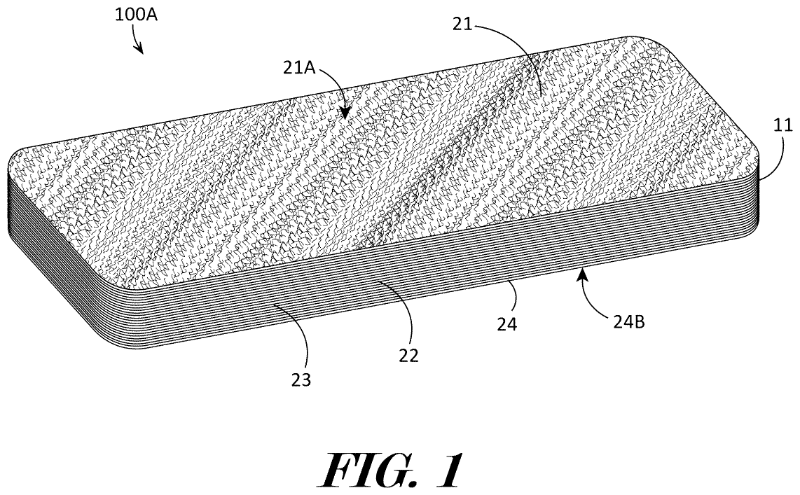

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new renewable cleaning device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

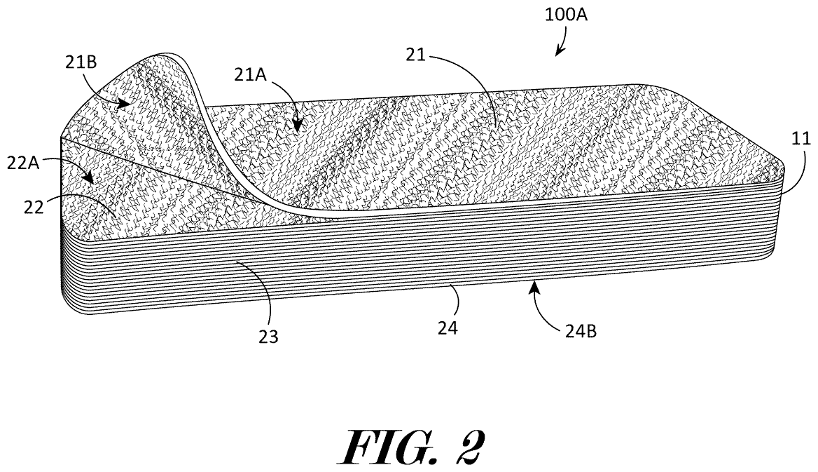

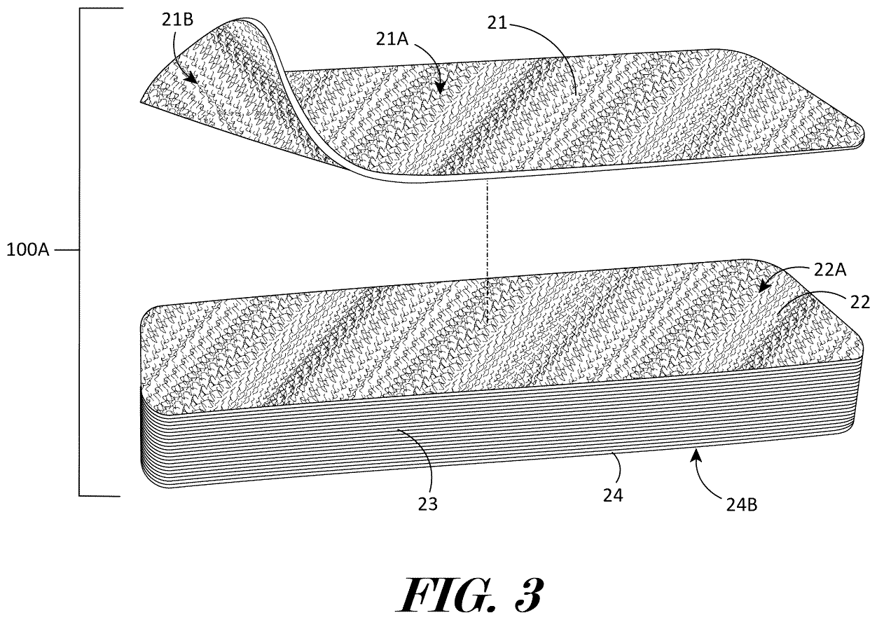

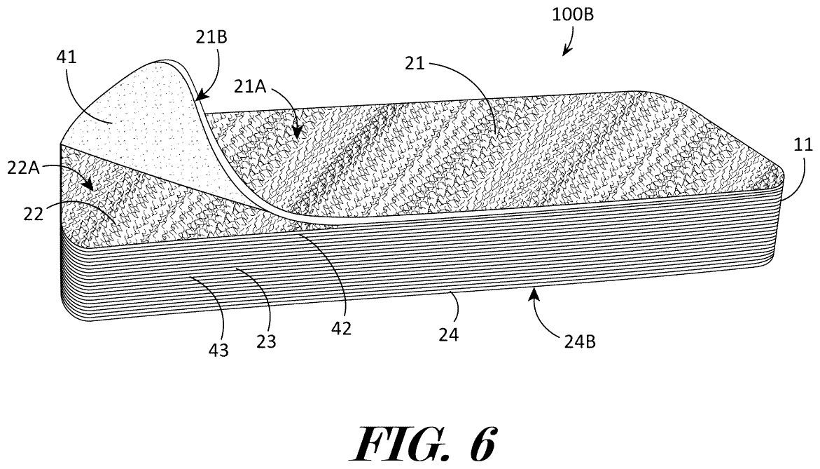

The present invention will now be described by example and through referencing the appended figures representing preferred and alternative embodiments. FIGS. 1-8 illustrate an example of a renewable cleaning device (“the device”) 100A, 100B, according to various embodiments. In some embodiments, and as perhaps best shown in FIGS. 1-4, the device 100A may include a body 11 having two or more, such as a plurality of flexible material layers 21, 22, 23, 24, and one or more, such as all, of the flexible material layers 21, 22, 23, 24, may comprise a cleaning agent dispersed therein. The flexible material layers 21, 22, 23, 24, may be coupled together via compressing the flexible material layers 21, 22, 23, 24, together and the flexible material layers 21, 22, 23, 24, may be removably coupled to each other so that they may be mechanically separated from each other, such as by peeling or pulling apart, without damaging the structural integrity of the flexible material layers 21, 22, 23, 24, as perhaps best shown in FIG. 3. Preferably, each flexible material layer 21, 22, 23, 24, of the device 100A, may include two major surfaces 21A, 21B, 22A, 22B, 23A, 23B, 24A, 24B, that may be disposed on opposite sides of the flexible material layers 21, 22, 23, 24, and that may function as cleaning surfaces of the device 100A. Once two adjacent flexible material layers 21, 22, 23, 24, are peeled apart or otherwise separated from each other, one or more of the newly exposed major surfaces 21A, 21B, 22A, 22B, 23A, 23B, 24A, 24B, may function as renewed cleaning surfaces of the device 100A.

A flexible material layer 21, 22, 23, 24, of the device 100A, 100B, may be made from or may comprise any flexible material which may be used for cleaning purposes. While the flexible material layers 21, 22, 23, 24, may be made from or may comprise any flexible material which may be used for cleaning purposes, preferably each flexible material layer 21, 22, 23, 24, may comprise a water absorbing material.

In some embodiments, a water absorbing material may comprise a synthetic sponge material. In preferred embodiments, each flexible material layer 21, 22, 23, 24, may comprise and/or may be polyvinyl alcohol (PVA) sponge. PVA Sponge has a porous structure made from water soluble PVA acetalized with an acid catalyst. The finished product becomes Poly Vinyl Formal-often referred to as “PVA Sponge”. During the acetalizing process, the pore forming agent or method (starch or air) is added. After a water soluble porous structure is made, the agent (starch) is extracted. In the case of air pore forming, there is no need to remove any additional material. In some embodiments, one or more, such as each, flexible material layer 21, 22, 23, 24, of the plurality of flexible material layers 21, 22, 23, 24, may comprise a synthetic sponge material, such as which may be made of polyvinyl alcohol sponge, polyester sponge, polyurethane sponge, melamine foam, or synthetic expanded and foam materials.

In some embodiments, one or more, such as each, flexible material layer 21, 22, 23, 24, of the plurality of flexible material layers 21, 22, 23, 24, may comprise a water absorbing material that may be a natural sponge material, such as animal fiber or sea sponges, vegetable cellulose sponge, or other naturally occurring sponge material. In some embodiments, one or more, such as each, flexible material layer 21, 22, 23, 24, of the plurality of flexible material layers 21, 22, 23, 24, may comprise a water absorbing material that may be a fabric cloth material, such as all-purpose cloth made from microfiber fabric impregnated with polyvinyl alcohol (PVA), e.g., Molecular Cleaning PVA microfiber. Microfiber fabric impregnated with polyvinyl alcohol provides water absorption capabilities that are many times greater than other existing commonly used sponge and fabric materials. Further example fabric cloth materials may include synthetic fabrics such as polyester, polyamide, acrylic, nylon, rayon, acetate, spandex, spandex blends, and natural fabrics such as coir, cotton, terry cloth, hemp, jute, linen, ramie, wool, silk, or any other suitable flexible natural or synthetic material including combinations of materials.

In preferred embodiments, the flexible material layers 21, 22, 23, 24, may be may be removably coupled to each other so that they may be mechanically separated from each other, such as by peeling or pulling apart, without damaging the structural integrity of the flexible material layers 21, 22, 23, 24, via compressing the flexible material layers 21, 22, 23, 24, together. In preferred embodiments, the flexible material layers 21, 22, 23, 24, may be removably coupled together so that each flexible material layer 21, 22, 23, 24, may be mechanically separated from an adjacent flexible material layer 21, 22, 23, 24, such as by peeling or pulling apart, without damaging the structural integrity of the flexible material layers 21, 22, 23, 24, via compressing the flexible material layers 21, 22, 23, 24, with a compression of between 100 grams to 1,000 kilograms per centimeter squared, optionally subjecting the flexible material layers 21, 22, 23, 24, to heat of between 60 to 260 degrees Celsius.

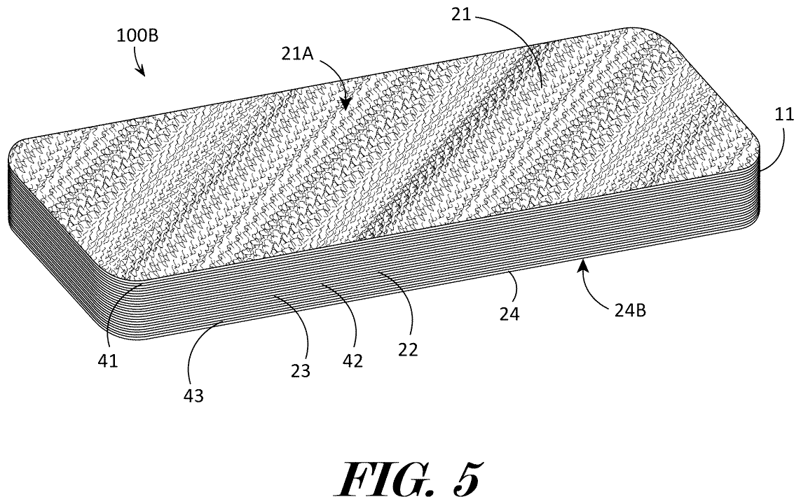

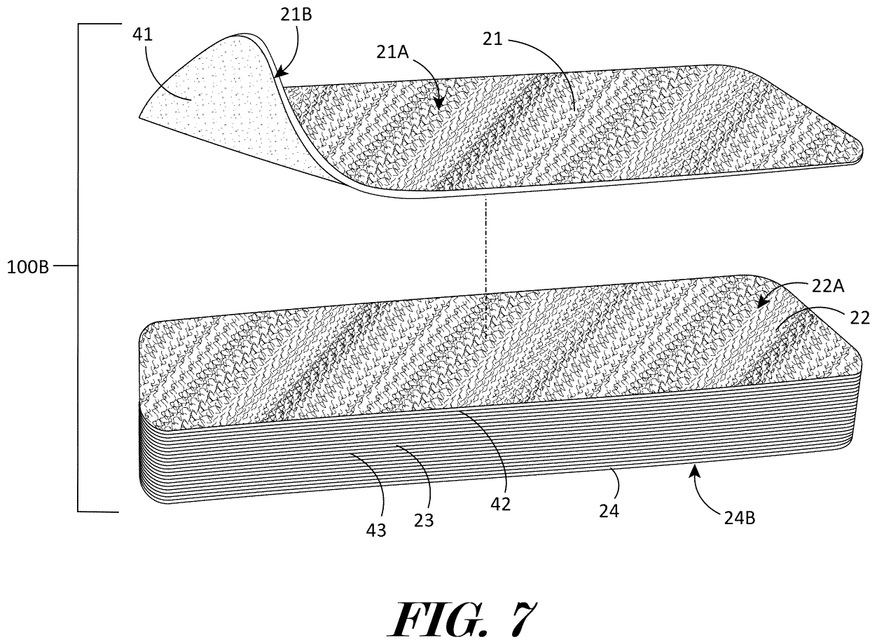

In some embodiments and as perhaps best shown in FIGS. 5-8, the device 100B may comprise a body 11 having a plurality of flexible material layers 21, 22, 23, 24, and a plurality of adhesive layers 41, 42, 43. Each flexible material layer 21, 22, 23, 24, of the plurality of flexible material layers 21, 22, 23, 24, may be coupled to an adjacent flexible material layer 21, 22, 23, 24, via an adhesive layer 41, 42, 43, of the plurality of adhesive layers 41, 42, 43. The plurality of adhesive layers 41, 42, 43, may removably couple the plurality of flexible material layers 21, 22, 23, 24, together so that two adjacent flexible material layers 21, 22, 23, 24, may be peeled apart or otherwise separated in a non-damaging manner. Each flexible material layer 21, 22, 23, 24, of the plurality of flexible material layers 21, 22, 23, 24, may include two major surfaces 21A, 21B, 22A, 22B, 23A, 23B, 24A, 24B, that may be disposed on opposite sides of the flexible material layers 21, 22, 23, 24, and that may function as cleaning surfaces of the device 100B. Each flexible material layer 21, 22, 23, 24, may be removably coupled to an adjacent flexible material layer 21, 22, 23, 24, via an adhesive layer 41, 42, 43, so that they may be mechanically separated from each other, such as by peeling or pulling apart, without damaging the structural integrity of the flexible material layers 21, 22, 23, 24, as perhaps best shown in FIG. 7. Once two adjacent flexible material layers 21, 22, 23, 24, are peeled apart or otherwise separated from each other, one or more of the newly exposed major surfaces 21A, 21B, 22A, 22B, 23A, 23B, 24A, 24B, may function as renewed cleaning surfaces of the device 100B.

The device 100A, 100B, may comprise a plurality of flexible material layers 21, 22, 23, 24. In preferred embodiments, the device 100A, 100B, may comprise at least two flexible material layers 21, 22, 23, 24, such as two, three, four, five, six, seven, eight, nine, ten, etc., flexible material layers 21, 22, 23, 24. In further preferred embodiments, the device 100A, 100B, may comprise at least ten flexible material layers 21, 22, 23, 24, such as ten, eleven, twelve, thirteen, fourteen, fifteen, sixteen, seventeen, eighteen, or more flexible material layers 21, 22, 23, 24.

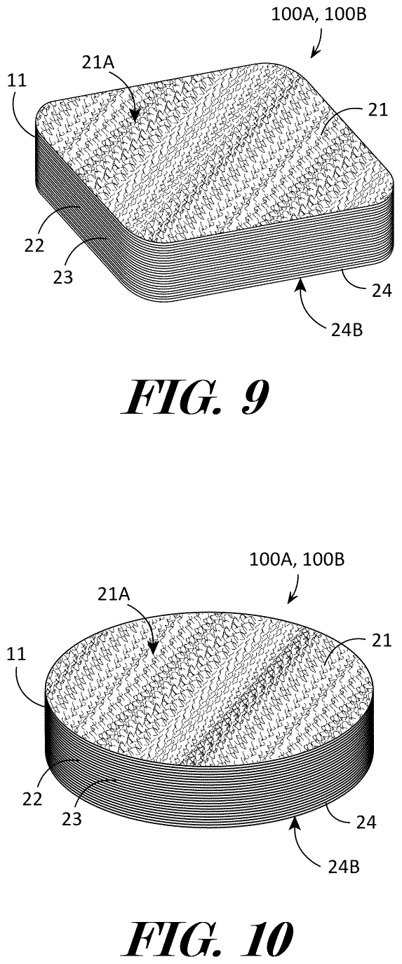

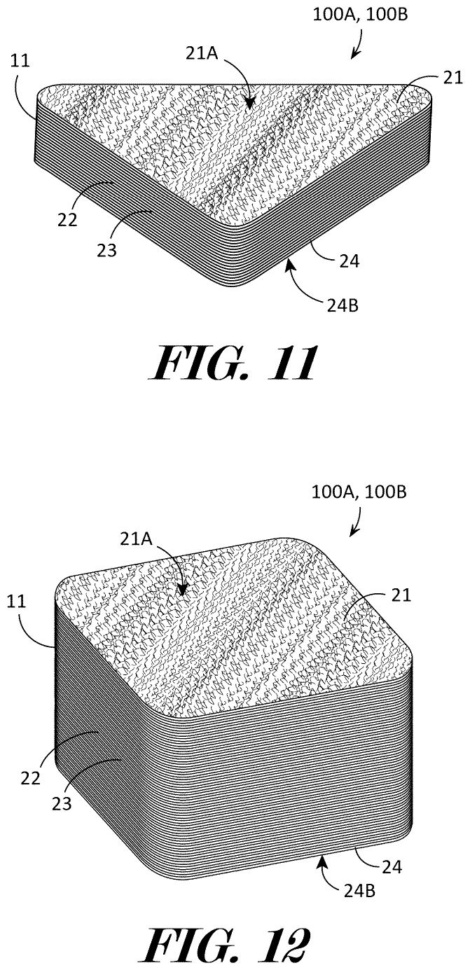

Flexible material layers 21, 22, 23, 24, and therefore the body 11, may be configured in any size and shape. In preferred embodiments, flexible material layers 21, 22, 23, 24, may comprise a generally rectangular prism shape as shown in FIGS. 1-3 and 5-7, optionally having rounded corners, so that when the flexible material layers 21, 22, 23, 24, are coupled together via the adhesive layers 41, 42, 43, the body 11 may comprise a generally rectangular prism shape, optionally having rounded corners, having a thickness defined by the thickness of the flexible material layers 21, 22, 23, 24, and the adhesive layers 41, 42, 43. In further embodiments, the flexible material layers 21, 22, 23, 24, and the adhesive layers 41, 42, 43, (and therefore the body 11) may comprise a generally square prism shape as shown in FIG. 9, a cylindrical shape as shown in FIG. 10, a generally triangular prism shape as shown in FIG. 11, a cube shape as shown in FIG. 12, or any other shape, including combinations of shapes. The thickness dimension of a flexible material layer 21, 22, 23, 24, may comprise its smallest dimension, while its length and width dimensions may comprise its two largest dimensions. For example, a flexible material layer 21, 22, 23, 24, having a three inch by four inch rectangular prism shape, may have a thickness dimension that may be less than fifty percent of its largest dimension, and more preferably less than ten percent of its largest dimension. Preferably, the thickness dimension of a flexible material layer 21, 22, 23, 24, may be between 0.0625 inches and 0.25 inches (1.58 millimeters and 6.35 millimeters).

In some embodiments, the device 100B may comprise one or more adhesive layers 41, 42, 43. In preferred embodiments, the device 100B may comprise at least two adhesive layers 41, 42, 43, such as two, three, four, five, six, seven, eight, nine, ten, etc., adhesive layers 41, 42, 43. In further preferred embodiments, the device 100B may comprise at least eleven adhesive layers 41, 42, 43, such as eleven, twelve, thirteen, fourteen, fifteen, sixteen, seventeen, eighteen, or more adhesive layers 41, 42, 43. Adhesive layers 41, 42, 43, 23, may be configured in any size and shape. Preferably, an adhesive layer 41, 42, 43, may be shaped or applied to substantially cover (over 90 percent) of a major surface 21A, 21B, 22A, 22B, 23A, 23B, 24A, 24B, to which it is applied or adhered to.

An adhesive layer 41, 42, 43, may be made from or may comprise any flexible adhesive material which may be suitable for removably coupling two flexible material layers 21, 22, 23, 24, together and which may be flexible to allow the flexible material layers 21, 22, 23, 24, and therefore the body to be bent and flexed for use during cleaning, adsorbing, and rubbing tasks. In preferred embodiments, one or more, such as each, adhesive layer 41, 42, 43, may comprise a flexible waterproof adhesive material, such as described in the following paragraphs.

In some embodiments, a flexible adhesive material may comprise a hot melt adhesive. Hot melt adhesives are brought to liquid form with heat and can be used to coat entire surfaces before the adhesive cools into a solid polymer. Many industrial sectors appreciate them for their eco-friendliness, safety and shelf life. Different types of hot melt adhesives include EVA-based, APAO-based and those that are pressure-sensitive. Polyurethane hot melts are also available and may be used.

In some embodiments, a flexible adhesive material may comprise a reactive hot melt adhesive. Unlike non-reactive hot melt, reactive hot melt adhesives generate additional chemical bonds after the solidification process. This results in stronger adhesion once cured, expanded bonding as well as a higher resistance to moisture, heat and chemicals.

In some embodiments, a flexible adhesive material may comprise a thermosetting adhesive. Thermosetting adhesives are usually available in two-part forms. Resin and Hardener are mixed to obtain a desired setting time. The resin and hardener can be used in one-part form, however these aren't as common because they must be stored in low temperatures. Storing them in high temperatures can cause the desired reaction to occur prematurely, resulting in a much lower shelf life.

In some embodiments, a flexible adhesive material may comprise a pressure sensitive adhesive (PSA). Adhesives in this category are low modulus elastomers, meaning they do not require much pressure to deform and can be used on wet surfaces. They are quite durable for light load applications and are normally purchased as tapes or labels for non-structural applications. Pressure sensitive adhesives are usually based on an elastomer compounded with a suitable tackifier (e.g., a rosin ester). The elastomers can be based on acrylics, which can have sufficient tack on their own and do not require a tackifier. Styrene block copolymers (SBC), also called styrene copolymer adhesives and rubber-based adhesives, have good low-temperature flexibility, high elongation, and high heat resistance. They are frequently used in hot melt adhesive applications, where the composition retains tack even when solidified; however non-pressure-sensitive formulations are also used. They usually have A-B-A structure, with an elastic rubber segment between two rigid plastic endblocks. High-strength film formers as standalone, increase cohesion and viscosity as an additive. Water-resistant, soluble in some organic solvents; cross-linking improves solvent resistance. Resins associating with endblocks (cumarone-indene, α-methyl styrene, vinyl toluene, aromatic hydrocarbons, etc.) improve adhesion and alter viscosity. Resins associating to the midblocks (aliphatic olefins, rosin esters, polyterpenes, terpene phenolics) improve adhesion, processing and pressure-sensitive properties. Addition of plasticizers reduces cost, improves pressure-sensitive tack, decrease melt viscosity, decrease hardness, and improves low-temperature flexibility. The A-B-A structure promotes a phase separation of the polymer, binding together the endblocks, with the central elastic parts acting as cross-links; SBCs do not require additional cross-linking. Styrene-butadiene-styrene (SBS) is used in high-strength PSA applications, styrene-ethylene/butylene-styrene (SEBS) in low self-adhering non-woven applications, and styrene-ethylene/propylene (SEP) and styrene-isoprene-styrene (SIS) are used in low-viscosity high-tack PSA applications.

In some embodiments, a flexible adhesive material may comprise a contact adhesive. Contact adhesives are elastomeric and are applied to both items being bonded together. Once the solvent evaporates, the items are brought into direct contact. These types of adhesives are found in rubber cement or countertop laminates.

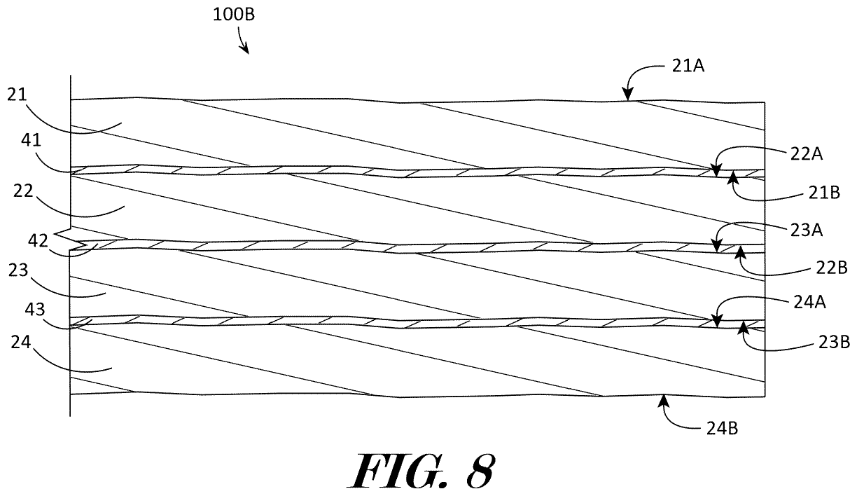

Referring now to the example device 100B of FIG. 8 having four flexible material layers 21, 22, 23, 24, each flexible material layer 21, 22, 23, 24, of the device 100B may comprise two major surfaces 21A, 21B, 22A, 22B, 23A, 23B, 24A, 24B. The two major surfaces 21A, 21B, 22A, 22B, 23A, 23B, 24A, 24B, of a flexible material layer 21, 22, 23, 24, may comprise the two largest surfaces of the flexible material layer 21, 22, 23, 24. The two major surfaces 21A, 21B, 22A, 22B, 23A, 23B, 24A, 24B, of a flexible material layer 21, 22, 23, 24, may be positioned on opposite sides of the flexible material layer 21, 22, 23, 24, so that the two major surfaces 21A, 21B, 22A, 22B, 23A, 23B, 24A, 24B, face away from each other. For example, a flexible material layer 21, 22, 23, 24, having a thin rectangular prism shape, may comprise two major surfaces 21A, 21B, 22A, 22B, 23A, 23B, 24A, 24B, that may be the two largest rectangular surfaces of the flexible material layer 21, 22, 23, 24. For example, a flexible material layer 21, 22, 23, 24, having a three inch by four inch rectangular prism shape, may have two major surfaces 21A, 21B, 22A, 22B, 23A, 23B, 24A, 24B, that are approximately three inches by four inches. Preferably, major surfaces 21A, 21B, 22A, 22B, 23A, 23B, 24A, 24B, of a flexible material layer 21, 22, 23, 24, may be generally flat or planar in shape.

Still referring to the example device 100B of FIG. 8, in some embodiments, the device 100B may comprise a first outer flexible material layer 21 and a second outer flexible material layer 24. In further embodiments, the device 100B may comprise a first outer flexible material layer 21, a second outer flexible material layer 24, and one or more, such as a plurality of inner flexible material layers 22, 23. The first outer flexible material layer 21 may have an upper major surface 21A and the second outer flexible material layer 24 may have a lower major surface 24B, and the upper major surface 21A and the lower major surface 24B may face away from each other so that the upper major surface 21A and the lower major surface 21B are not in contact with an adhesive layer 41, 42, 43. The first outer flexible material layer 21 may have a lower major surface 21B and the second outer flexible material layer 24 may have an upper major surface 24A, and the lower major surface 21B of the first outer flexible material layer 21 and the upper major surface 24A of the second outer flexible material layer 24 may face towards each other (and face towards any inner flexible material layer and adhesive layer 41, 42, 43 positioned between the first outer flexible material layer 21 and a second outer flexible material layer 24).

Still referring to the example device 100B of FIG. 8, in preferred embodiments, the device 100B may comprise a plurality of flexible material layers 21, 22, 23, 24, having a plurality of inner flexible material layers 22, 23. Each inner flexible material layer 22, 23, of the plurality of inner flexible material layers 22, 23, may comprise a two major surfaces 22A, 22B, 23A, 23B, and each major surface 22A, 22B, 23A, 23B, of each inner flexible material layer 22, 23, may be coupled to an adjacent flexible material layer 21, 22, 23, 24, via an adhesive layer of the plurality of adhesive layers 41, 42, 43. In further embodiments, at least one inner flexible material layer 22, 23, of the plurality of inner flexible material layers 22, 23, may have two major surfaces 22A, 22B, 23A, 23B, that are each substantially (over 90 percent) covered with an adhesive layer 41, 42, 43, of the plurality of adhesive layers 41, 42, 43. In further embodiments, at least one major surface 22A, 22B, 23A, 23B, of at least one inner flexible material layer 22, 23, of the plurality of inner flexible material layers 22, 23, may be substantially covered with an adhesive layer 41, 42, 43, of the plurality of adhesive layers 41, 42, 43. In further embodiments, each major surface 22A, 22B, 23A, 23B, of each inner flexible material layer 22, 23, of the plurality of inner flexible material layers 22, 23, may be substantially covered with an adhesive layer 41, 42, 43, of the plurality of adhesive layers 41, 42, 43.

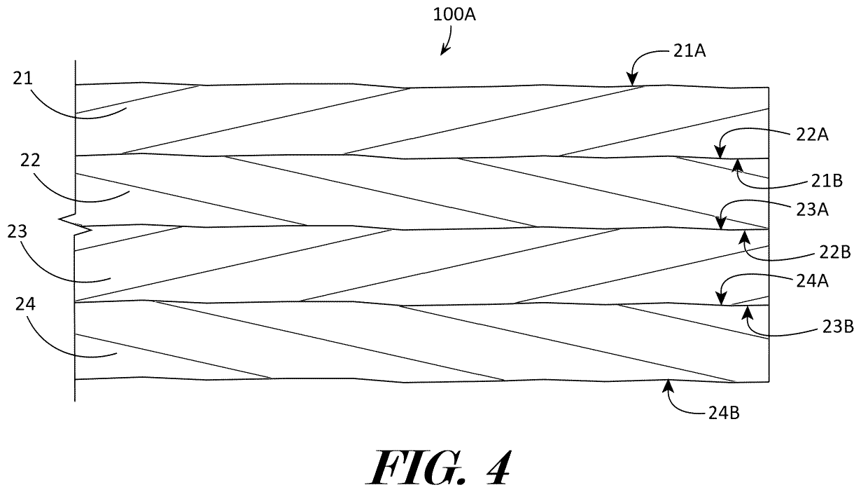

While the three preceding paragraphs have referenced the example device 100B of FIG. 4 having four flexible material layers 21, 22, 23, 24, and three adhesive layers 41, 42, 43, for simplicity of figure labeling and numbering of elements, it should be understood that the description of these paragraphs apply to other embodiments disclosed herein having any number of flexible material layers 21, 22, 23, 24, and adhesive layers 41, 42, 43.

In preferred embodiments, the device 100A, 100B, may comprise at least two flexible material layers 21, 22, 23, 24, such as three, four, five, six, seven, eight, nine, ten, etc., flexible material layers 21, 22, 23, 24. In further preferred embodiments, the device 100A, 100B, may comprise at least ten flexible material layers 21, 22, 23, 24, such as eleven, twelve, thirteen, fourteen, fifteen, sixteen, seventeen, eighteen, or more flexible material layers 21, 22, 23, 24.

In preferred embodiments, the device 100B may comprise at least one adhesive layer 41, 42, 43, such as three, four, five, six, seven, eight, nine, ten, etc., adhesive layers 41, 42, 43. In further preferred embodiments, the device 100B may comprise at least eleven adhesive layers 41, 42, 43, such as twelve, thirteen, fourteen, fifteen, sixteen, seventeen, eighteen, or more adhesive layers 41, 42, 43, and more preferably a number of adhesive layers 41, 42, 43, that is one less than the number of flexible material layers 21, 22, 23, 24.

In some embodiments, one or more flexible material layers 21, 22, 23, 24, of the device 100A, 100B, may comprise a cleaning agent that may be dispersed within the material of the one or more flexible material layers 21, 22, 23, 24. In preferred embodiments, each flexible material layer 21, 22, 23, 24, of the device 100A, 100B, may comprise a cleaning agent that may be dispersed within the material of the flexible material layers 21, 22, 23, 24.

A cleaning agent may comprise one or more chemicals that may be used to remove stains on clothes, carpet, furniture and upholstery, ceramic tile, stone tile, wood flooring, other types of floor materials, automotive and vehicle surfaces, shoe fabric, shoe leather, shoe sole material, other shoe materials, glass, painted surfaces, stainless steel, or any other surface that is commonly cleaned with chemical agents. In preferred embodiments, a cleaning agent may be a water-based cleaner so that the cleaning agent is soluble in water and so that water is a solvent of the cleaning agent (e.g., soluble preferably meaning that the cleaning agent dissolves in water to give a solution with a concentration of at least 0.1 moles per liter at room temperature). Water-based cleaners are aqueous cleaners with the ability to eliminate oil and dissolving contaminants. They can chemically react with these pollutants, making them increasingly dissolvable in water. As the name suggests, water-based cleaners use water as their primary solvent. In addition to water, they include detergents, pH modifiers, builders, chelating agents, and various other compounds. The purpose of adding a large range of other components in the cleaner is to enhance their cleaning properties, making them more suitable for a wide number of applications. Some example cleaning agent chemicals include water soluble detergents, water soluble surfactants, water soluble enzymes, water soluble solvents, and water soluble bleaching agents. Surfactants help to lift and suspend the stain, enzymes break down organic stains, solvents dissolve oily and greasy stains, and bleaching agents help to remove color from stains.

Surfactants typically include a water-repellent and a water-attracting part, they enable water and oil to mix; they can form foam and facilitate the detachment of dirt. In some embodiments, a surfactant of a cleaning agent may include an anionic surfactant that contains an anionic functional group at its head, such as sulfate, sulfonate, phosphate, and carboxylates. Prominent alkyl sulfates include ammonium lauryl sulfate, sodium lauryl sulfate (sodium dodecyl sulfate, SLS, or SDS), and the related alkyl-ether sulfates sodium laureth sulfate (sodium lauryl ether sulfate or SLES), and sodium myreth sulfate. Other anionic surfactants include: Alkylbenzene sulfonates, Sodium C10-16 Alky Benzenesulfonate, Docusate (dioctyl sodium sulfosuccinate), Perfluorooctanesulfonate (PFOS), Perfluorobutanesulfonate, Alkyl-aryl ether phosphates, and Alkyl ether phosphates. Carboxylates are the most common surfactants and comprise the carboxylate salts (soaps), such as sodium stearate. More specialized species include sodium lauroyl sarcosinate and carboxylate-based fluorosurfactants such as perfluorononanoate, perfluorooctanoate (PFOA or PFO). In further embodiments, a surfactant of a cleaning agent may include: a surfactant having a cationic head group, a zwitterionic surfactant; a non-ionic surfactant, an ethoxylate surfactant, a fatty alcohol ethoxylate surfactant; special ethoxylated fatty esters and oils; ethoxylated amines and/or fatty acid amides; terminally blocked ethoxylates; fatty acid esters of polyhydroxy compounds; fatty acid esters of glycerol; fatty acid esters of sorbitol; fatty acid esters of sucrose; alkyl polyglucosides; amino acid-based surfactants; and gemini surfactants.

Further example cleaning agents may include detergents that may include anionic detergents, cationic detergents, non-ionic detergents, and amphoteric detergents. Optionally, a cleaning agent may comprise one or more alkylbenzene sulfonates, such as sodium c10-16 alky benzenesulfonate, which are soap-like compounds that are more soluble in hard water, because the polar sulfonate (of detergents) is less likely than the polar carboxylate (of soap) to bind to calcium and other ions found in hard water. In some embodiments, a cleaning agent may comprise one or more surfactants, foam regulators, builders, bleach, bleach activators, enzymes, dyes, and fragrances. In preferred embodiments, a cleaning agent may comprise one or more detergents and/or one or more surfactants. In further embodiments, a cleaning agent may comprise one or more detergents, surfactants, enzymes, solvents, organic salts and chelating agents, such as tetrasodium glutamate di-acetate glutamic acid di-acetic acid (GLDA), ethylene-diamine-tetra acetic acid (EDTA), hydroxyl-ethylethylene-diamine-tri-acetic acid (HEDTA), rimercaptotriazine, potassium/sodiumthiocarbonate, and sodium dimethyldithiocarbamate, etc., and/or bleaching agents.

Preferably, one or more flexible material layers 21, 22, 23, 24, of the device 100A, 100B, may comprise a cleaning agent that may be dispersed, impregnated, or otherwise disposed within the material of the one or more flexible material layers 21, 22, 23, 24. In some embodiments, each flexible material layer 21, 22, 23, 24, of the device 100A, 100B, may comprise a cleaning agent that may be dispersed, impregnated, or otherwise disposed within the material of each flexible material layer 21, 22, 23, 24, by having the body 11 (comprising the flexible material layers 21, 22, 23, 24) positioned in a liquid cleaning agent so that the liquid cleaning agent is absorbed in each flexible material layer 21, 22, 23, 24, and then the body 11 may be removed from the liquid cleaning agent and allowed to dry so that the flexible material layers 21, 22, 23, 24, each comprise dried liquid cleaning agent. In preferred embodiments, each flexible material layer 21, 22, 23, 24, of the device 100A, 100B, may comprise microfiber fabric impregnated with polyvinyl alcohol, and each flexible material layer 21, 22, 23, 24, may comprise a cleaning agent dispersed, impregnated, or otherwise disposed within the material of each flexible material layer 21, 22, 23, 24, by having the body 11 (comprising the flexible material layers 21, 22, 23, 24) positioned in a liquid cleaning agent so that the liquid cleaning agent is absorbed in each flexible material layer 21, 22, 23, 24, and then the body 11 may be removed from the liquid cleaning agent and allowed to dry so that the flexible material layers 21, 22, 23, 24, each comprise dried liquid cleaning agent.

While some exemplary shapes and sizes have been provided for elements of the device 100A, 100B, it should be understood to one of ordinary skill in the art that the flexible material layers 21, 22, 23, 24, adhesive layers 41, 42, 43, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A renewable cleaning device, the device comprising:
a body having at least two flexible material layers, wherein each flexible material layer of the at least two flexible material layers comprises a water absorbing material, wherein a flexible material layer of the at least two flexible material layers comprises a cleaning agent, wherein the at least two flexible material layers are coupled together via compressing the at least two flexible material layers together, and wherein the at least two flexible material layers are removably coupled to each other so that the at least two flexible material layers may be mechanically separated from each other without damaging the structural integrity of the at least two flexible material layers.

2. The device of claim 1, wherein each flexible material layer of the at least two flexible material layers comprises microfiber fabric impregnated with polyvinyl alcohol.

3. The device of claim 1, wherein each flexible material layer of the at least two flexible material layers comprises the cleaning agent.

4. The device of claim 1, wherein the cleaning agent is soluble in water.

5. A renewable cleaning device, the device comprising:
a body having at least two flexible material layers and at least one adhesive layer, wherein each flexible material layer of the at least two flexible material layers comprises a water absorbing material, wherein a flexible material layer of the at least two flexible material layers comprises a cleaning agent, wherein two flexible material layers of the at least two flexible material layers are coupled together via one adhesive layer of the at least one adhesive layer, and wherein the one adhesive layer removably couples the two flexible material layers together.

6. The device of claim 5, further comprising a plurality of flexible material layers and a plurality of adhesive layers, wherein each flexible material layer of the plurality of flexible material layers is coupled to an adjacent flexible material layer via an adhesive layer of the plurality of adhesive layers, and wherein the plurality of adhesive layers removably couple the plurality of flexible material layers together.

7. The device of claim 5, wherein each flexible material layer of the at least two flexible material layers comprises the cleaning agent.

8. The device of claim 5, wherein each flexible material layer of the at least two flexible material layers comprises microfiber fabric impregnated with polyvinyl alcohol.

9. The device of claim 5, wherein the cleaning agent is soluble in water.

10. The device of claim 5, wherein a flexible material layer of the plurality of flexible material layers comprises a fabric cloth material.

11. The device of claim 5, wherein each flexible material layer of the plurality of flexible material layers comprises a fabric cloth material.

12. The device of claim 5, wherein an adhesive layer of the plurality of adhesive layers comprises a flexible waterproof adhesive.

13. The device of claim 5, wherein each adhesive layer of the plurality of adhesive layers comprises a flexible waterproof adhesive.

14. The device of claim 5, further comprising a first outer flexible material layer having an upper major surface and a second outer flexible material layer having a lower major surface, wherein the upper major surface and the lower major surface face away from each other, and wherein the upper major surface and the lower major surface are not in contact with an adhesive layer of the plurality of adhesive layers.

15. The device of claim 5, wherein the plurality of flexible material layers comprises a plurality of inner flexible material layers, wherein each inner flexible material layer of the plurality of inner flexible material layers comprises a two major surfaces, and wherein each major surface of each inner flexible material layer is coupled to an adjacent flexible material layer via an adhesive layer of the plurality of adhesive layers.

16. The device of claim 15, wherein at least one inner flexible material layer of the plurality of inner flexible material layers has two major surfaces that are each substantially covered with an adhesive layer of the plurality of adhesive layers.

17. The device of claim 15, wherein at least one major surface of at least one inner flexible material layer of the plurality of inner flexible material layers is substantially covered with an adhesive layer of the plurality of adhesive layers.

18. The device of claim 15, wherein each major surface of each inner flexible material layer of the plurality of inner flexible material layers is substantially covered with an adhesive layer of the plurality of adhesive layers.

19. The device of claim 5, wherein each flexible material layer of the plurality of flexible material layers is made from a first material, and wherein each adhesive layer of the plurality of adhesive layers is made from a second material that is not the first material.

20. The device of claim 5, further comprising a number of flexible material layers and a number of adhesive layers, wherein the number of adhesive layers is one less than the number of flexible material layers.
